(19) United States
(12) Patent Application Publication
(10) Pub. No.: US 2021/0264805 A1
(43) Pub. Date: Aug. 26, 2021

(54) DATA SERVICE PERMISSIONS

(71) Applicant: LENOVO (Singapore) PTE. LTD., New Tech Park (SG)

(72) Inventors: Mark Patrick Delaney, Raleigh, NC (US); John Carl Mese, Cary, NC (US); Nathan J. Peterson, Oxford, NC (US); Russell Speight VanBlon, Raleigh, NC (US); Arnold S. Weksler, Raleigh, NC (US)

(21) Appl. No.: 16/796,664

(22) Filed: Feb. 20, 2020

(51) Int. Cl. G09B 7/02; G06F 21/62

(52) U.S. Cl. CPC G09B 7/02; G06F 21/62

(57) ABSTRACT

For data service permissions, a processor identifies a user of a data service. The processor further determines an access status for the user based on a user status and a user activity. The processor restricts access to the data service in response to a restricted activity status.

### FIELD

The subject matter disclosed herein relates to permissions and more particularly relates to data service permissions.

### BACKGROUND

Users often make queries of data services.

### BRIEF SUMMARY

An apparatus for data service permissions is disclosed. The apparatus includes a processor and a memory that stores code executable by the processor. The processor identifies a user of the data service. The processor further determines an access status for the user based on a user status and a user activity. The processor restricts access to the data service in response to a restricted activity status. A method and program product also perform the functions of the apparatus.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a data service system;

FIG. 2A is a schematic block diagram illustrating one embodiment of user data;

FIG. 2B is a schematic block diagram illustrating one embodiment of educational data;

FIG. 3 is drawings illustrating embodiments of electronic devices;

FIG. 4 is a schematic block diagram illustrating one embodiment of a computer; and

FIG. 5 is a schematic flow chart diagram illustrating one embodiment of a data service permission method.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules and may be embodied in any suitable form and/organized within any suitable type of data structure. The operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

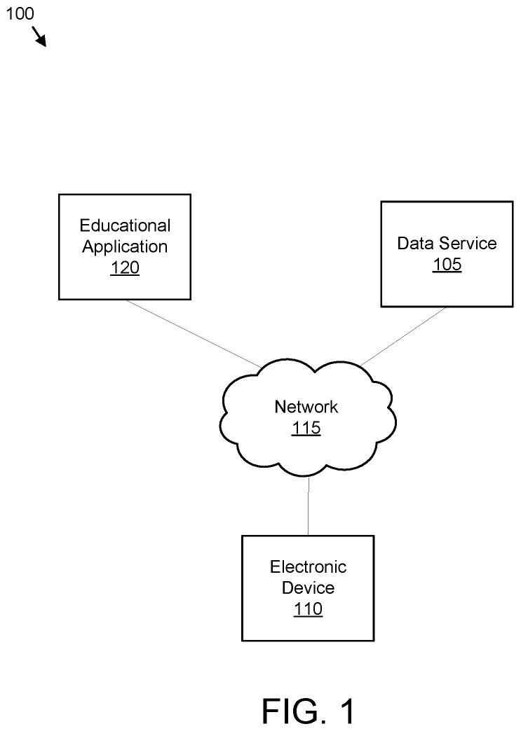

FIG. 1 is a schematic block diagram illustrating one embodiment of a data service system 100. The data service system 100 supports queries from a user via an electronic device 110. For example, the user may query the data service system 100 about a topic of interest. In the depicted embodiment, the data service system 100 includes a data service 105, an electronic device 110, and the network 115. In addition, the data service system 100 may include an educational application 120.

The electronic device 110 may employ a voice interface, a graphical interface, and/or a text interface to interact with the user. The network 115 may be the Internet, a mobile telephone network, a wi-fi network, a wide area network, a local area network, or combinations thereof. The electronic device 110 may query the data service 105 via the network 115. The data service 105 may be a reference site such as WIKIPEDIA®, a search engine, a query interface, or combinations thereof. For example, the user may speak a question to the electronic device 110. The electronic device 110 may select one or more data services 105 and present the question to the data services 105. The electronic device 110 may receive an answer from the one or more data services 105.

In one embodiment, the educational application 120 may manage a classroom, manage a curriculum, present lessons, provide and/or grade homework, test knowledge, or combinations thereof for the user. For example, the educational application 120 may be an educational product such as LENOVO® LANSCHOOL®.

In one embodiment, the educational application 120 may be hosted on a server. In addition, the educational application 120 may be embodied in the electronic device 110. The data service 105 may also be hosted on a server. In addition, the data service 105 may reside on the electronic device 110.

The user may be tasked with completing an assignment. The assignment may come from the educational application 120. In addition, the assignment may come from a physical school and/or classroom. The assignment may be designed to cause the user to generate answers and/or to test the user's knowledge. However, the user may attempt to access the data service 105 to retrieve answers to the assignment, diminishing the benefit of the assignment to the user.

The embodiments determine an access status for the user and restrict access to the data service 105 in response to a restricted activity status as will be described hereafter. As a result, the user is restricted from using the data service 105 when use of the data service 105 is not consistent with the educational goal of an assignment. Thus, the utility and efficiency of the electronic device 110, the data service 105, and/or the educational application 120 is improved.

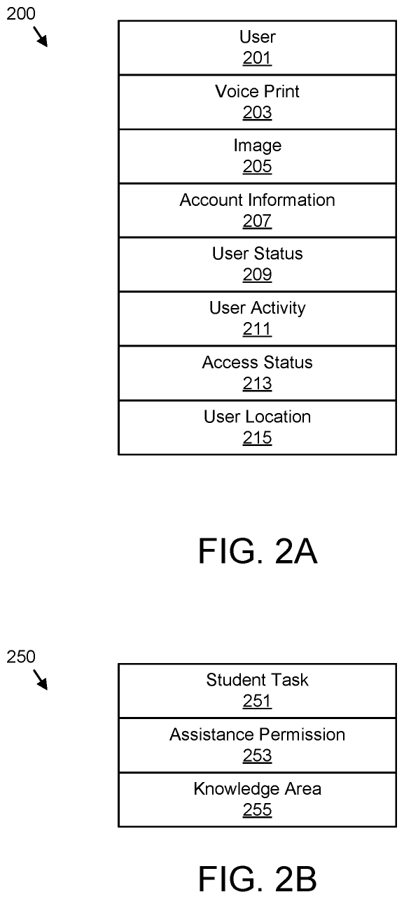

FIG. 2A is a schematic block diagram illustrating one embodiment of user data 200. The user data 200 may record information relating to the user and the user's activities. The user data 200 may be organized as a data structure in a memory. In the depicted embodiment, the user data 200 includes the user 201, a voiceprint 203, an image 205, account information 207, the user status 209, user activity 211, an access status 213, and a user location 215.

The user 201 may uniquely identify each user of the electronic device 110. The voice print 203 may be used to identify the user 201 from speech. The image 205 may be used to identify the user 201 using facial recognition, image recognition, and the like. The account information 207 may identify the user 201 from access to online accounts by the user 201.

The user status 209 may indicate what the user 201 is doing, should be doing, and/or is scheduled to be doing. For example, the user status 209 may indicate that the user 201 is engaged in homework and/or should be engaged in homework. Table 1 lists exemplary user statuses 209.

TABLE 1

User Status 209
Minor Student
Adult Student
Homework
Worksheet
Drill
Knowledge Testing
Test Taking
Physical Activity
Game
Video

In addition, a data service restriction may be associated with each user status 209. For example, the test taking user status 209 may be associated with the “restricted” data service restriction. In addition, no data service restriction may be associated with a user status 209.

In one embodiment, the educational application 120 provides the user status 209. For example, the electronic device 110 may query the educational application 120 for the user status 209. In a certain embodiment, the user status 209 includes a knowledge area such as multiplication, American history, and the like.

The user activity 211 may indicate the nature of the user's interaction with the data service 105. The user activity 211 may include a frequency of queries to the data service 105. Each query may be time stamped. In addition, the user activity 211 may include a knowledge area of the queries to the data service 105.

The access status 213 may be determined for the user 201 based on the user status 209 and the user activity 211. The determination of the access status 213 is described in more detail hereafter. The user location 215 may indicate where the user 201 is located when accessing the data service 105. For example, the user location 215 may indicate a testing center, a Department of Motor Vehicles office, and the like.

FIG. 2B is a schematic block diagram illustrating one embodiment of educational data 250. The educational data 250 describes educational activities that the user 201 may be engaged in using the educational application 120. The educational data 250 may be organized as a data structure in a memory. In the depicted embodiment, the educational data 250 includes a student task 251, an assistance permission 253, and a knowledge area 255.

The student task 251 indicates a task that has been assigned to the user 201. The assistance permission 253 indicates a level of assistance from a data service 105 that is permitted to the user 201 while performing the student task 251. Assistance permissions 253 may be set for each type of student task 251. For example, each test taking student task 251 may have a restricted assistance permission 253.

Alternatively, each student task 251 may be assigned an assistance permission 253 without regards to type. For example, a first homework student task 251 may have a restricted assistance permission 253 while a second homework student task 251 may have an allowed assistance permission 253. Table 2 shows exemplary student tasks 251 and assistance permissions 253.

TABLE 2

| | |
|---|---|
| Student Task 251 | Assistance Permission 253 |
| Homework | Allowed |
| Worksheet | Up to 3 queries |
| Drill | Up to 5 queries |
| Knowledge Testing | Restricted |
| Test Taking | Restricted |

The knowledge area 255 may indicate the knowledge area for the student task 251. For example, the knowledge area 255 may be multiplication, American history, and the like.

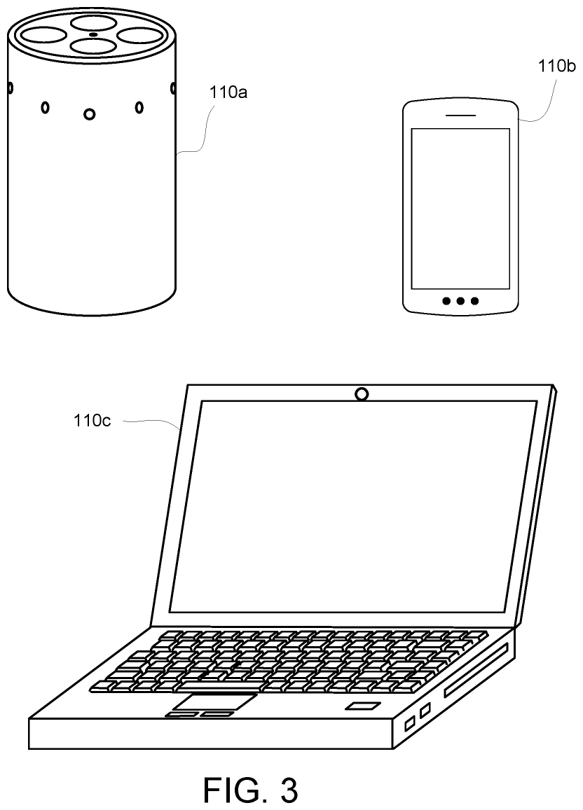

FIG. 3 is drawings illustrating embodiments of electronic devices 110. In the depicted embodiment, electronic devices 110 include an audio appliance 110a, a mobile telephone 110b, and a laptop computer 110c. Other types of electronic devices 110 may be employed.

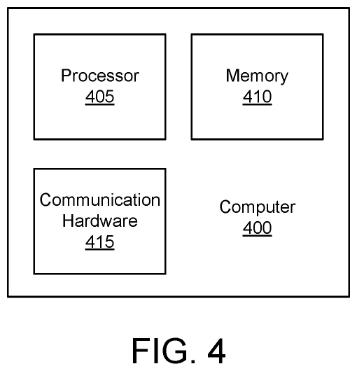

FIG. 4 is a schematic block diagram illustrating one embodiment of a computer 400. The computer 400 may be embodied in the electronic device 110 and/or in a server hosting the educational application 120 and/or data service 105. In the depicted embodiment, the computer 400 includes a processor 405, a memory 410, and communication hardware 415. The memory 410 may include a semiconductor storage device, a hard disk drive, an optical storage device, or combinations thereof. The memory 410 may store code. The processor 405 may execute the code. The communication hardware 415 may communicate with other devices such as the network 115.

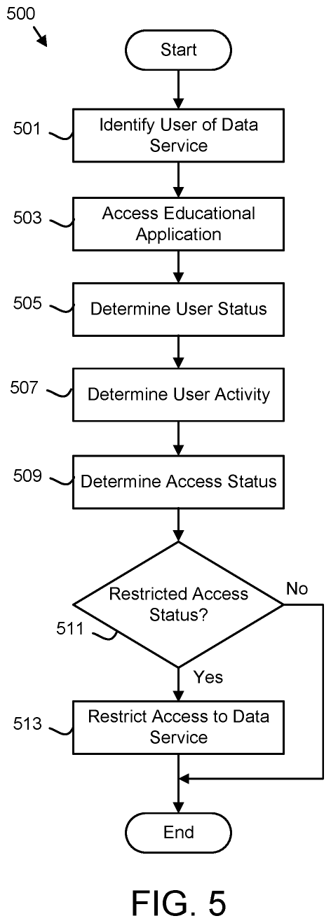

FIG. 5 is a schematic flow chart diagram illustrating one embodiment of a data service permission method 500. The method may determine the access status 213 for the user 201 and restrict access to the data service 105 in response to a restricted activity status 213. The method 500 may be performed by the computer 400 and/or processor 405.

The method 500 starts, and in one embodiment, the processor 405 identifies 501 the user 201 of the data service 105. In a certain embodiment, the processor 405 compares speech from the user 201 to the voice print 203 to identify 501 the user 201. In addition, the processor 405 may compare a captured image of the user 201 from a camera with the stored image 205 to identify 501 the user 201. In a certain embodiment, the user 201 is identified 501 by comparing the username and/or user ID that is used to access the educational application 120 and/or data service 105 to the account information 207.

The processor 405 may access 503 the educational application 120. In one embodiment, the processor 405 retrieves the educational data 250.

The processor 405 may determine 505 the user status 209 for the user 201. The user status 209 may be determined 505 based on the user interaction with the electronic device 110. For example, if the user 201 is accessing the educational application 120 to perform a homework student task 251, the user status 209 may be set to “homework.” Similarly, if the user 201 is playing a game on the electronic device 110, the user status 201 may be set to “game.” In addition, the user status 209 may be determined 505 from a captured image of the user 201.

In one embodiment, the user status 209 is determined 505 based on what the user 201 should be doing as indicated by the educational application 120. For example, if the educational application 120 indicates that the user 201 has a worksheet student task 251, the user status 209 may be a worksheet user status 209. In a certain embodiment, if the educational application 120 indicates that the user 201 has a plurality of student tasks 251, the user status 209 may include each of the plurality of student tasks 251.

The processor 405 may determine 507 the user activity 211 for the user 201. In one embodiment, the user activity 211 includes the knowledge area for each query to the data service 105. In addition, each query may be time stamped. As a result, the user activity 211 includes information on the frequency of queries and/or the frequency of queries by knowledge area.

The processor 405 determines 509 the access status 213 for the user 201. The access status 213 may be based on the user status 209 and the user activity 211. In one embodiment, the processor 405 determines 509 a user activity 211 that matches the user status 209. For example, if the user is making queries with a multiplication knowledge area, the processor 405 may determine 509 a match with a test taking user status 209 with a multiplication knowledge area.

In a certain embodiment, the access status 213 is determined from the educational application 120. For example, the user activity 211 may be a student task 251 from the educational data 250. The processor 405 may determine whether the knowledge area 255 of the student task 251 is equivalent to the knowledge area of the user status 209. The processor 405 may only determine the user activity 211 is the student task 251 if the knowledge area 255 of the student task 251 is equivalent to the knowledge area of the user status 209.

The access status 213 may be “restricted” in response to the user status 209 of minor student and the user activity 211 of knowledge testing. In one embodiment, the access status 213 is “restricted” in response to the user activity 211 of knowledge testing and/or homework and a restricted assistance permission 253.

In one embodiment, the access status 213 is restricted in response to a user activity 211 of a test taking and a user location 215 of a testing facility. In a certain embodiment, the access status 213 is restricted in response to a user activity 211 that correlates to a student task 251 and a restricted assistance permission 253.

For example, if the user activity 211 is a student task 251, the processor 405 may further determine 509 the access status 213 to be the assistance permission 253 corresponding to the student task 251. In one embodiment, the access status 213 is “unrestricted” if the user activity 211 is not a student task 251.

The processor 405 may determine 511 if the access status 213 is a restricted access status 213. In response to the access status 213 being the restricted access status 213, the processor 405 restricts 513 access to the data service 105 and the method 500 ends. If the access status 213 is not restricted access status 213, the method 500 ends without restricting access to the data service 105.

The embodiments identify the user 201 of the data service 105 and determine an access status 213 for the user 201 based on the user status 209 and the user activity 211. The embodiments further restrict access to the data service 105 in response to a restricted activity status 213. As a result, a student user 201 is automatically prevented from inappropriately using the data service 105, improving the utility and efficiency of the data service 105 and the electronic device 110.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a processor;
a memory that stores code executable by the processor to:
identify a user of a data service;
determine an access status for the user based on a user status and a user activity; and
restrict access to the data service in response to a restricted activity status.

2. The apparatus of claim 1, wherein the code is further executable by the processor to access an educational application and wherein the access status is further determined from the educational application.

3. The apparatus of claim 1, wherein the access status is restricted in response to the user status of minor student and the user activity of knowledge testing.

4. The apparatus of claim 1, wherein the access status is restricted in response to the user activity of knowledge testing and/or homework and a restricted assistance permission.

5. The apparatus of claim 1, wherein the access status is restricted in response to a user activity of a test taking and a user location of a testing facility.

6. The apparatus of claim 1, wherein the access status is restricted in response to a user activity that correlates to a student task and a restricted assistance permission for the student task.

7. The apparatus of claim 1, wherein the user is identified using voice recognition using a voice print.

8. The apparatus of claim 1, wherein the user is identified using image recognition using an image.

9. The apparatus of claim 1, wherein the user is identified based on account information.

10. A method comprising:
identifying, by use of a processor, a user of a data service;
determining an access status for the user based on a user status and a user activity; and
restricting access to the data service in response to a restricted activity status.

11. The method of claim 10, the method further comprising accessing an educational application and wherein the access status is further determined from the educational application.

12. The method of claim 10, wherein the access status is restricted in response to the user status of minor student and the user activity of knowledge testing.

13. The method of claim 10, wherein the access status is restricted in response to the user activity of knowledge testing and/or homework and a restricted assistance permission.

14. The method of claim 10, wherein the access status is restricted in response to a user activity of a test taking and a user location of a testing facility.

15. The method of claim 10, wherein the access status is restricted in response to a user activity that correlates to a student task and a restricted assistance permission for the student task.

16. The method of claim 10, wherein the user is identified using voice recognition using a voice print.

17. The method of claim 10, wherein the user is identified using image recognition using an image.

18. The method of claim 10, wherein the user is identified based on account information.

19. A program product comprising a computer readable storage medium that stores code executable by a processor, the executable code comprising code to:
identify a user of a data service;
determine an access status for the user based on a user status and a user activity; and
restrict access to the data service in response to a restricted activity status.

20. The program product of claim 19, wherein the code is further executable by the processor to access an educational application and wherein the access status is further determined from the educational application.
